(19) United States
(12) Patent Application Publication
(10) Pub. No.: US 2002/0056010 A1
(43) Pub. Date: May 9, 2002

(54) Method and apparatus for transmitting compressed data transparently over a client-server network

(75) Inventors: Patrick D. Lincoln, Woodside, CA (US); David W. J. Stringer-Calvert, Sunnyvale, CA (US); Steven M. Dawson, Menlo Park, CA (US)

Correspondence Address: THOMASON, MOSER & PATTERSON, LLP, Attorneys at Law, SUITE 100, 595 SHREWSBURY AVENUE, SHREWSBURY, NJ, 07702, US

(73) Assignee: SRI International

(21) Appl. No.: 09/812,223

(22) Filed: Mar. 19, 2001

Related U.S. Application Data
(60) Provisional application No. 60/247,184, filed on Nov. 9, 2000.

(51) Int. Cl. G06F 15/16

(52) U.S. Cl. 709/247; 709/219

(57) ABSTRACT

Client-transparent methods and apparatus are taught for compressing and transmitting requested network server data and uncompressing this data on client browsers. A network request for a file from a typical client specifies a list of acceptable encoding schemes. In response, the file is compressed using a substantially lossless encoding format or codes that is one of the acceptable encoding schemes listed. In some embodiments, compression is performed dynamically in response to requests. A particular content delivery server may be chosen to handle each network request for a file at least partly based upon one or more criteria indicating a relative quality of connectivity between the selected server and the requesting client. Compression is performed as a further element of a content delivery business service, and may be performed either dynamically or statically and in either a centralized or distributed manner. A proxy-server may be used to intercept and automatically modify client requests, in order to facilitate compression, transmittal, and decompression of network data to requesting clients in a client-transparent manner.

### CROSS-REFERENCE TO RELATED APPLICATIONS

This application claims benefit of U.S. provisional patent application Ser. No. 60/247,184, filed Nov. 9, 2000, which is herein incorporated by reference.

### TECHNICAL FIELD OF THE INVENTION

Data compression, and its use for improving data transmission performance in client-server telecommunications networks.

### BACKGROUND OF THE INVENTION

The need for faster access to Internet-based information is widely recognized. (Indeed, the World Wide Web has been sarcastically nicknamed the “World Wide Wait” in testimony to this need.) Advances have recently been achieved in improving the speed and throughput of traffic flow through the Internet by using techniques such as the replication and caching of content (especially relatively static content) at so-called “edge” servers located around topological edges of the Internet. When a client requests particular data content from a network source, this approach automatically forwards or re-routes the client's request to an edge server where that content has previously been replicated or cached and that is positioned relatively close to the requesting client (or otherwise determined to have a good quality of connectivity with that client). The desired content is then served to the client from that point, instead of having to traverse the interior “cloud” of the Internet all the way from an original, central server. Content delivery technology of this nature is now commercially available and widely used; see, for example, http://www.digisle.net; http://www.akamai.com). An industry consortium is working on aspects of improved, next-generation content delivery technology; see http://www.i-cap.org/index.cfm. Nevertheless, despite such advances, traffic congestion and delays on the Internet remain a serious business problem. For example, one major concern is that edge-based content delivery technologies often do little to address performance over “the last mile” of the network from edge server to client (end-user), where the speed/quality of connection is often the poorest.

Data compression can reduce bandwidth consumption for a given quantity of original content, and therefore offers a possible way to ameliorate the “last mile” problem as well as reduce network traffic congestion generally. With respect to some types of data/content, compression is already widely used on the Internet. For example, lossy compression schemes are often used to reduce bandwidth consumption of audiovisual multimedia data files such as video (MPEG), audio (MP3), and static images (JPEG), albeit at some sacrifice of quality and authenticity relative to the original source image/data. Typically, a publisher of such content on the Internet prepares the files in compressed format in advance, and the files are stored in a directory on the web server in that compressed format.

Lossless data compression techniques are well known in the arts that are applicable to a wide variety of content/data file types such as textual data. See e.g. U.S. Pat. No. 5,126,739 (“Data Compression Apparatus and Method”). However, although theoretically applicable to enormous quantities of Internet content, in practice such lossless compression techniques are rarely used for content published on the Internet. Perhaps one reason is that text files and the like are often edited over time, through iterative versions, and such editing must take place on uncompressed file formats. Such document editing tools do not often incorporate document compression seamlessly into the file saving process; whereas audio visual file creation tools traditionally include the popular compression formats as an integral option (if not the default) in saving files. Perhaps another reason is the large density of typical multimedia audiovisual data files, relative to text or html files.

Whatever the reason, what is needed is an approach that takes full advantage of the benefits of data compression for the multitude of uncompressed Internet data files, in a manner that overcomes the historical resistance to such compression described in the previous paragraph. One current approach that does overcome resistance is automatic lossless compression of data files by specialized hardware embedded in modems and other communication devices. However, since such standard hardware implementations tend to be stream-based, they are inherently less efficient than gzip or similar batch-mode compression tools. Furthermore, hardware compression is effective only on those segments of the communication path equipped at both ends with compression/decompression devices, (e.g., between the modem of the client and the modem of the client's ISP), and does not provide the benefits of end-to-end (origin server or edge-server to browser) compression.

### SUMMARY OF THE INVENTION

The present invention provides a client-transparent method and apparatus for compressing and transmitting requested web server data and uncompressing this data on client browsers.

More specifically, the present invention comprises a method for transmitting compressed data from a hosting server to a requesting client across a packet-switched client-server computer network. Elements of the method include receiving a network request from the client for a file, the request specifying a list of acceptable encoding schemes; dynamically compressing the file in response to the network request, the compression codec being one of the acceptable encoding schemes; and transmitting the compressed file from the hosting server to the client via the network in fulfillment of the request.

In one embodiment of the invention, the compression is substantially lossless, meaning not only strictly lossless data compression in the standard sense, but also further including additional optimizations so long as the data that is removed does not substantively affect the display of information by standard network browsers, such as deletion of source code comments and/or extraneous blank characters.

The invention also comprises a business method for use with content delivery networks. The business method efficiently delivers copies of a customer's electronic file across a packet-switched, client-server computer network. Elements of the method include hosting copies of a customer's file at a plurality of content delivery network servers, as a component of a business service; compressing the file using a compression codec, as a further component of the business service; receiving, by a selected one of the servers, a network request for the file from a requesting client, the request specifying a list of recognized file encoding schemes including the compression codec; and responding to the network request, as a further component of the business service, by transmitting the compressed file over the network from the selected server to the requesting client. In alternative embodiments, as best suited for particular applications and practitioners, the business service component of compressing the file may be performed dynamically in response to the network request, or may be performed in advance of the network request, or may be performed in advance for purposes of some requests and dynamically for other requests. Moreover, file compression may be performed in a centralized manner with the results distributed to the servers of the content delivery network, or may be performed in a distributed manner locally at each of the content delivery servers, or may be performed locally for some servers and in a centralized manner with distribution of results for other servers.

The business method further includes selecting a particular content delivery server to handle each network request at least partly based upon one or more criteria indicating a relative quality of connectivity between the selected server and the requesting client. For example preferred connectivity criteria include metrics indicative of geographical distance, topological distance, bandwidth, latency, jitter, financial cost, and/or traversal of political boundaries.

The present invention comprises a proxy-server embodiment for compression, transmittal, and decompression of network data to requesting clients in a client-transparent manner. In this embodiment, a proxy server intercepts the network request from the client and, in response generates a modified request (such as by simply modifying the file name extension) that is forwarded to a hosting sever for a version of the file to be compressed using a compression codec that is one of the acceptable encoding schemes listed in the request parameters. The compressed version of the requested file is retrieved from the hosting server and transmitted to the requesting client in fulfillment of the original request. In further features of the invention the compressed version of the file may be created dynamically in response to the network request or may be created in advance and stored by the hosting server. The hosting server may itself be part of a content delivery server network within which copies of the requested file have been distributed. The proxy server may preferably generate several modified requests, each corresponding to a different one of the acceptable encoding formats listed in the request, in case compressed versions of the file are not available for all of the listed encoding formats.

In an important, illustrative embodiment of the invention, the network is the Internet and the network request is an HTTP protocol request. In some embodiments, the requested file may itself be dynamically generated in response to the network request, and is also compressed in accordance with the invention. The invention may also be advantageously practiced with requesting clients that include “thin” (or “light”) wireless clients, for whom compression is of particular value and for whom display information is typically very amenable to substantially lossless compression methods.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates an enhanced architecture for a client server network in accordance with one embodiment of the present invention;

FIG. 2 is a flow diagram illustrating a method for dynamically compressing, transmitting, and decompressing data content over a client-server network;

FIG. 3 illustrates an enhanced client-sever network architecture in accordance with another embodiment of the present invention, including a content delivery sub-network deployed at the network edge;

FIG. 4 is a flow diagram illustrating a method for compressing, transmitting, and decompressing data content in a client-server network including a content delivery sub-network deployed at the network edge; and

FIG. 5 illustrates an enhanced client-sever network architecture in accordance with another embodiment of the present invention, including one or more proxy servers.

### DETAILED DESCRIPTION OF THE INVENTION

Basic Embodiment

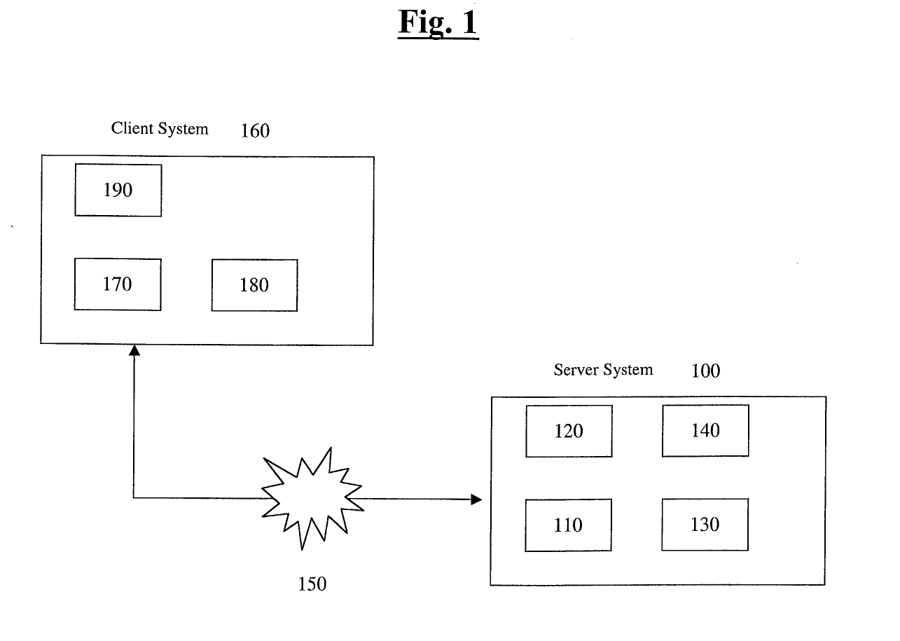

FIG. 1 illustrates an enhanced architecture for a client server network in accordance with one embodiment of the present invention.

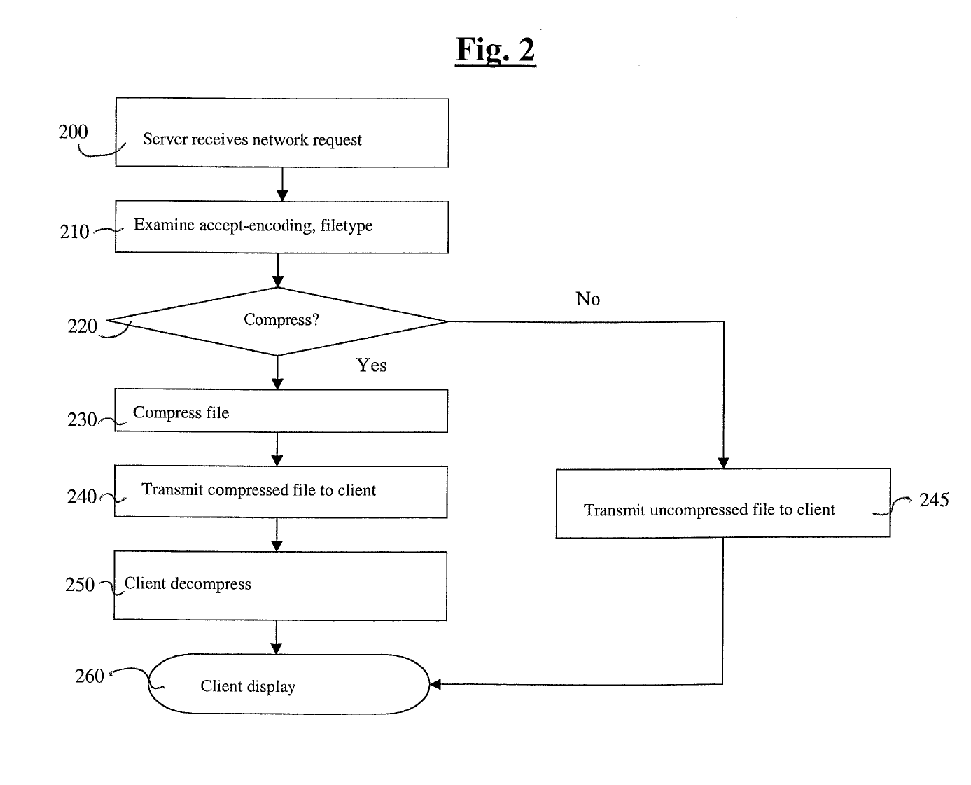

Server computer system 100 comprises a conventional server computer system, with standard capabilities and components including web/network server subsystem 110, file storage subsystem 120, and one or more encoding utilities 130. In one embodiment of the present invention, server computer system 100 is further enhanced with dynamic compression module 140, which functions automatically and dynamically to compress data files in a substantially lossless manner in response to client requests. The preferred operation of module 140 is discussed in detail below, in connection with FIG. 2.

Client computer system 160 comprises a conventional computer system, including conventional browser software 170, one or more decoding utilities 180 (preferably configured as “plug-ins” for browser 170), and user display/UI device 190 (e.g. standard monitor, keyboard, mouse). Server computer system 100 and client computer system 160 communicate electronically via packet-switched client-server network infrastructure 150 such as the Internet.

FIG. 2 is a flow diagram illustrating a method for dynamically compressing, transmitting, and decompressing data content over a client-server network such as that of FIG. 1.

At step 200, network server subsystem 110 of server 100 receives an HTTP request across network 150 from client 160/ browser 170, requesting retrieval of a data file stored in file storage subsystem 120 of server 100. The request includes a parameter set by browser 170 listing all of the data encoding schemes (including any data compression codecs) for which client browser 170 is ready and able to perform automatic decoding using available local utilities such as plug-ins 180. In one embodiment, the “accept-encoding” parameter that is defined as part of the HTTP network protocols is used. Relevant details of this protocol are described further below (under “Client-Server Protocol for Request and Transmission of Encoded Data”).

At step 210, dynamic compression module 140 examines the “accept-encoding” parameter list for the request, in order to make a determination (at decision point 220) of whether or not to compress the requested file. Module 140 preferably also considers the file-type of the requested file. For example, if the requested file is a character-based data file such as a text file or HTML file, and the “accept-encoding” list includes a substantially lossless compression scheme (such as zip) that is available to server 100, then dynamic compression module 140 will preferably determine that compression is appropriate. At step 230, compression module 140 will then invoke an appropriate compression utility 130 (such as gzip) to compress the requested file. At step 240 the resulting compressed version of the file is transmitted by network server subsystem 110 to client 160 in response to the client's request, with an encoding parameter set to identify the compression scheme used by dynamic module 140. Once again, one embodiment, the “encoding” parameter defined as part of the HTTP network protocols is used. Relevant details of this protocol are described further below.

At step 250, browser 170 of client 160 receives the file, recognizes the “encoding” parameter and uses an appropriate decompression plug-in/utility 180 (e.g. “gunzip” for zip compression) to decompress the file. Note that since the compression scheme was chosen based on browser 170's own setting of the “accept-encoding” parameter, it is guaranteed that browser 170 will be able to decompress the file automatically using an available utility, assuming correct configuration of client browser 170. Browser 170 can then display the decompressed data content on display device 190 of client system 160. The end user of client system 160 thus enjoys the benefits of transparent compression, efficient transmission, and automatic decompression and display of his/her desired data.

In the event that server system 100 determines at decision point 220 not to compress the requested file (e.g. perhaps server 100 does not have any compression utilities conforming to the “accepted-encoding” parameters listed in the request), then the requested file is simply transmitted to client 160 in uncompressed form at step 245, and can be displayed in straightforward fashion on client device 190 at step 260.

It should be noted that for present purposes, “substantially lossless” compression includes lossless data compression codecs in the standard sense, as well as further optimizations by which data is removed that does not substantively affect the ultimate display of information on client 160 by a standard browser 170. Examples of such further optimization in a preferred embodiment include deletion of source code comments (such as programmer/author comments in an HTML file) and/or extraneous blank characters.

Client-Server Protocols for Request and Transmission of Encoded Data

In the existing World Wide Web/Internet environment, client browsers generally request transmission of data content from web servers using the so-called HTTP protocol. Details may be found in RFC 2616, “Hypertext Transfer Protocol—HTTP/1.1”, R. Fielding, J. Gettys, J. Mogul, H. Frystyk, L. Masinter, P. Leach, T. Berners-Lee, June 1999, and will be familiar to skilled practitioners. Under this protocol, a client browser requesting data can specify not only the data file desired but also a set of parameters, including an “accept-encoding” parameter that identifies a list of data file encoding schemes which that browser is willing and able to accept. Typically, the browser will be configured to include in that list the encoding schemes for which that browser has easy access to a decoding routine (such as plug-in or similar local resource). For its part, the server responding to such a request will typically transmit not only the requested file, but also a set of parameters including an “encoding” parameter that identifies the encoding scheme, if any, applied to the requested file. The result is that if a server sends the client browser a data file that has been encoded in one of the encoding schemes included in the “accept-encoding” list, then the receiving browser will be able to immediately and automatically decode the file and present it for display to the end user in a transparent manner. In other words, the user need not be concerned with the mechanics of any encoding and decoding that take place; the end user simply enjoys display of the desired data content in the ordinary fashion.

In conventional applications, the “accept-encoding” parameter is most typically used to ensure that a server does not inadvertently transmit encoded data to a client browser that said browser could not decode and display. For example, if a client browser requests a file from a server that happens to be encoded and stored as a zipped file, but the browser's request does not include “zip” in the “accept-encoding” parameter list, then the server will sometimes automatically decode/unzip the file itself (or retrieve an alternate version in an unencoded format) and transmit a simple text or html version of the file instead of the zipped version. Alternatively, the server may send the postscript version and set the “encoding” parameter to “zip”; on receipt of the file, the browser will recognize the “encoding” as one that it cannot automatically decode, and so instead of attempting to display the contents the browser will notify the user of this problem and may invite the end user to download a copy of the file for future processing, etc.

However, the opposite is not generally implemented—namely, examining the “accept-encoding” to determine what encoding schemes might potentially be acceptable to a browser and on that basis encoding an otherwise unencoded data file in order to achieve a transmission benefit such as data compression. Thus, one embodiment of the present invention takes this opposite approach and utilizes the protocol in a novel manner, as one of the elements for implementing and achieving transparent, lossless compression, transmission, and decompression of data content over the network, as described above.

Edge-Based Embodiment

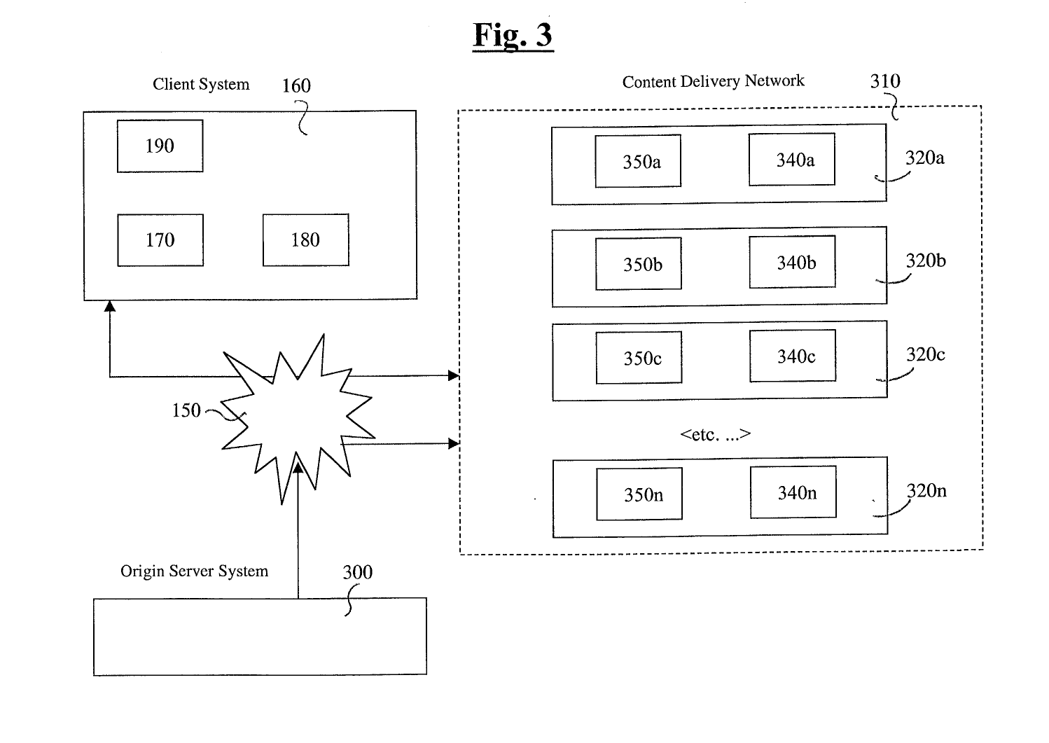

FIG. 3 illustrates enhanced client-sever network architecture in accordance with another embodiment of the present invention that exploits a content delivery sub-network deployed at the “edges” of the network.

Origin computer server system 300 includes a conventional computer system, equipped similarly as server system 100 in FIG. 1 except not necessarily including compression module 140. Origin system 300 hosts an originating copy of the file of interest. As described at greater length below, in some variations file compression in accordance with the present invention may take place in a distributed manner within content delivery network 310, or instead may take place in a more centralized manner such as at server 300 or elsewhere.

Content delivery sub-network 310 includes “edge” server nodes 320 (a)-(n) each hosting file replication directories 340, and standard network server subsystem software (not shown in drawing). As shown in FIG. 3, in some variations edge servers 320, each server also include compression module 350 (along with standard compression utilities, not shown explicitly in FIG. 3), whose function is to automatically compress data content losslessly in accordance with the present invention. As noted above and as discussed further below, in other variations of the edge-based embodiment, compression may take place in a more centralized manner.

Client computer system 160 is again included, as in the previous embodiment of FIG. 1. Communications among client system 160, origin server system 300, and content delivery sub-network 310 take place electronically via packet-switched client-server network infrastructure 150, such as the Internet.

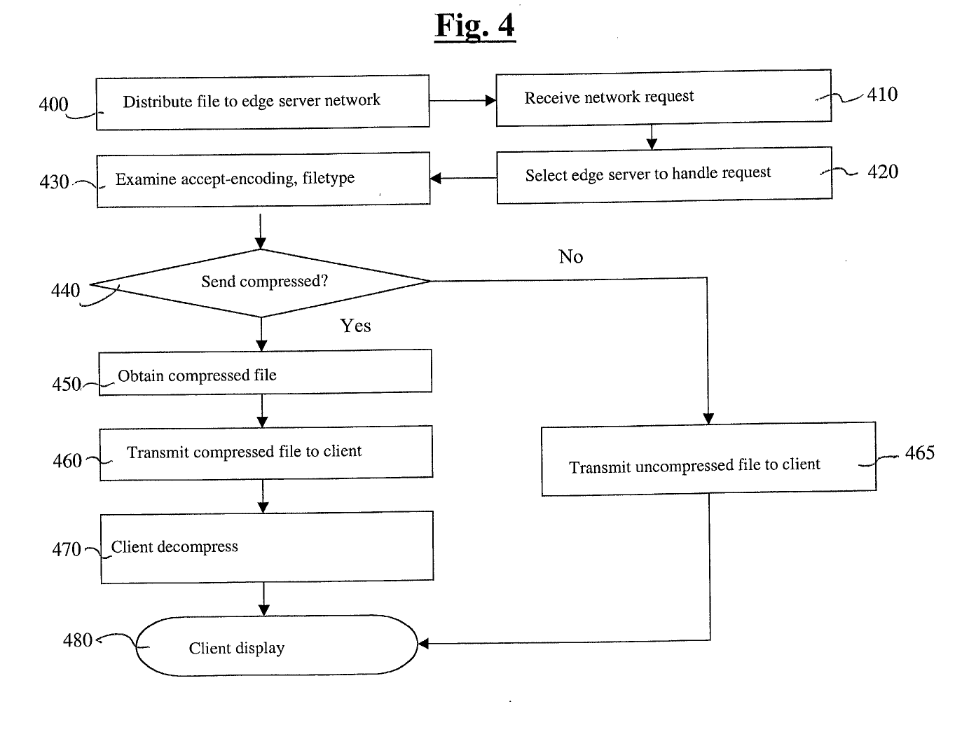

FIG. 4 is a flow diagram illustrating a method for compressing, transmitting, and decompressing data content in the context of an embodiment including an edge-based content delivery sub-network such as shown in FIG. 3.

At step 400, copies of the pertinent files on origin system 300 are distributed to file storage subsystems 340 of edge server nodes 320 in content delivery network 310, for more efficient distribution to clients. When client system 160 submits a request for this file from origin system 300, at steps 410 and 420 this request is received and is redirected automatically to a selected one of the edge servers 320. Preferably the edge server is selected at least partly on the basis of performance criteria, in particular best/closest connection to the requesting client 160. For example, selection criteria may preferably include connectivity estimates/metrics between the selected edge server 320 and client system 160, such as: geographical distance, topological distance, bandwidth, latency, jitter, financial costs (e.g. fees associated with any necessary traversals of commercial network backbone crossing points), and national/political boundaries that would be traversed. Note that the edge-based content delivery network technology utilized in the steps just described is known to skilled practitioners in the art and has been commercialized by companies including Digital Island and Akamai. For more details, see e.g. U.S. Pat. No. 6,185,598, entitled “Optimized Network Resource Location.”

As in the embodiment of FIGS. 1 and 2, the request from client 160 includes a parameter set by browser 170 listing all of the data encoding schemes (including any data compression codecs) for which browser 170 is ready and able to perform automatic decoding using available local utilities such as plug-ins 180. Again, preferably the “accept-encoding” parameter that is defined as part of the HTTP network protocols is used, as described above. At step 430, the selected edge server 320 examines the “accept-encoding” parameter list for a received HTTP request, so as to avoid sending a compressed file to client 160 unless said parameter list indicates a capability to accept the compression format. As in the embodiments described above in connection with FIGS. 1 and 2, file type is also preferably considered.

If the determination is made at step 440 that compression is appropriate, then at step 450 edge server 320 obtains a compressed version of the requested file. Here, as briefly alluded to above, at least several variations are possible. For example, with respect to the timing of compression, in some variations of the present invention the compression operation may be performed statically in advance, such as by compressing centrally (by origin server 300 or at a selected one of edge servers 320, for example) the candidate data files (files of appropriate data type) that are distributed among edge servers 320. Alternatively, compression may be performed dynamically in response to each individual HTTP request that is received by a particular edge server node 320, in a manner akin to that described above in connection with step 230 of FIG. 2. In this latter case, compression is preferably performed by the compression module 350 associated with the edge server node 320 handling the request, as shown in FIG. 3. Combinations of these variations are also possible. For example, some but not all of edge servers 320 may be equipped with compression module 350 and perform dynamic compression, whereas others may statically receive and store compressed versions in advance. In some variations, edge server 320 may compress a particular file only when requested, but the compressed results may be retained thereafter or cached for some limited time locally in file storage 340 for subsequent requests.

An advantage of the first approach (advance compression) is that storage space on the edge servers is potentially conserved—if files are stored only in their compressed format—since the hosted data files take up less space in compressed format. Another advantage of the first approach is that there is no added delay at the time of processing a given file request from a client, while there would be (modest) delay if compression is performed dynamically. On the other hand, it may be desirable for the hosting servers to store uncompressed versions of the files, for example in order to facilitate indexing of those files by the automated “web crawlers” of the major search engines. In that case, static/advance compression would cost more storage space, since both compressed as well as uncompressed versions of each file would need to be stored. Furthermore, information content that is served over the World Wide Web is often generated dynamically. For example, a web page listing current quotes for a user's stock portfolio is normally dynamically generated in response to a user's request, taking into account the latest stock prices and perhaps modifications to the contents of the user's portfolio. Increasingly, even some dynamic pages are served through “edge”-based content delivery networks (for example http://www.akamai.com/html/en/sv/edgescape_over.html describes an edge-based content customization service called “EdgeScape”). For dynamic pages, dynamic compression may sometimes be the only suitable alternative.

In all of these variations, the compressed data file is then transmitted from edge server node 320 to client system 160 via the network, with an “encoding” parameter set to reflect the compression scheme applied to the file. As previously discussed in the analogous steps 250-260 of FIG. 2, client browser 170 receives the file, recognizes the “encoding” parameter, and uses the appropriate decompression plug-in/utility 180 (e.g. “gunzip” for zip compression) to decompress the file. Once again, since the compression scheme was applied based on browser 170's own setting of the “accept-encoding” parameter, it is guaranteed that browser 170 will be able to decompress the file automatically using an available utility. Browser 170 can then display the decompressed data content to the end user on a standard display device 190 of client system 160.

At decision point 440, if it is determined not to transmit a compressed version of the file (for example, in the event the network request from client 160 does not list any compression schemes supported by edge server 320 as an accepted encoding), then at step 465 an uncompressed version of the file is preferably transmitted to the client 160/browser 170 for viewing. In variations using dynamic compression, the requested file would simply not be compressed; while in variations using advance/static compression, if a decompressed version is not also stored then the requested file would preferably be decompressed by edge server 320 using an available utility prior to transmission.

Thus, in the edge-based embodiments that have been described, customers of content delivery network 310—in other words, the respective owners of the files originating from origin server 300 and hosted by content delivery network 310—are provided with new and novel transparent compression services by virtue of the present invention. Content delivery networks featuring these added services can thus offer their customers the opportunity to transparently deliver requested data/files more rapidly to network users. Thus, the embodiments of the present invention offer strong competitive advantage to content delivery network companies.

Proxy Server Embodiment

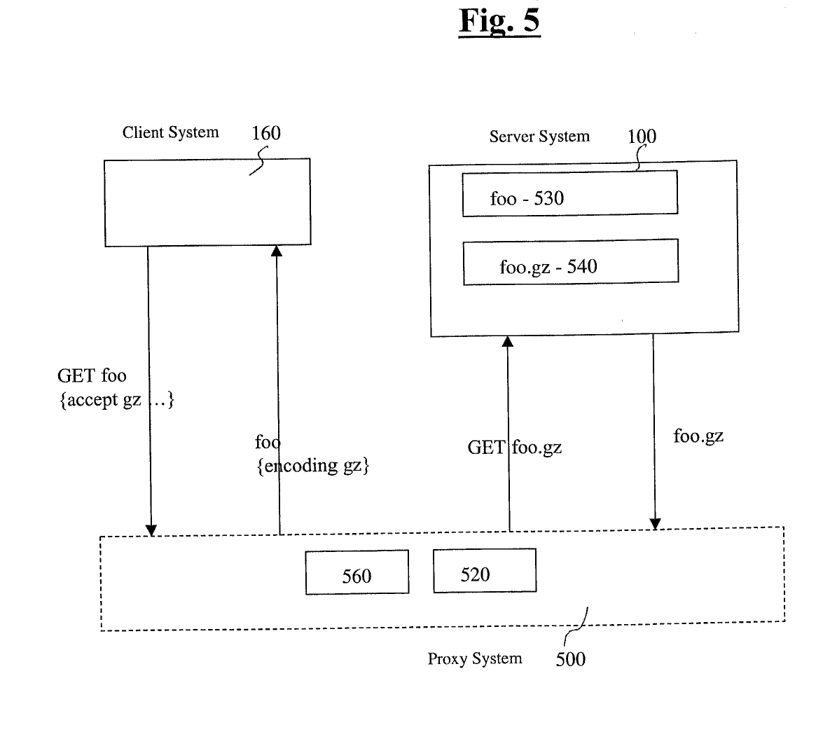

FIG. 5 illustrates enhanced client-sever network architecture in accordance with another embodiment of the present invention, including one or more proxy servers deployed intermediately between the requesting client and the hosting server.

Here again, the client and server interactions discussed are preferably transmitted via packet-switched client-server network 150, e.g., the Internet. FIG. 5 is drawn showing server system 100 as the network server hosting the requested data; but as will be apparent to skilled practitioners in light of the teachings herein, this proxy embodiment is equally applicable as a variant of the edge-based embodiment discussed above in connection with FIGS. 3-4. Thus, the hosting server in this embodiment could as well be one of edge servers 320, for example.

As illustrated in FIG. 5, requesting client 160 initiates a network request for a data file “foo” (merely an example name) 530 that resides on hosting server 100. As in the earlier embodiments, the request includes a parameter set by client browser 170 listing those data encoding/compression formats that browser 170 is able to receive. In this proxy-based embodiment, the network request is actually received by proxy server 500, effectively deployed intermediately between client 160 and server 100. As practitioners know, proxy servers can readily be established in typical networks such as the Internet simply by causing the network routing table entries for the identity of server 100 to point to the network (IP) address of proxy server 500 instead. An innovative function of proxy server 500 in this embodiment of the present invention, performed by logic module 520 as depicted in the drawing, is to automatically modify the request so as to specifically identify a compressed version of requested file 530. Thus, in the example illustrated in FIG. 5, the file name “foo” is modified by adding an extension “.gz” denoting a “zipped” version 540 of the “foo” file. Proxy server 500 then transmits the modified request to hosting server 100.

Hosting server 100 hosts one or more compressed versions of data file 530, including version 540 (“foo.gz” in this example). In variations of this proxy-based embodiment, one or more of the compressed file versions may be created in advance (on hosting server 100, or elsewhere and then distributed to hosting server 100), or they may instead be created dynamically in response to requests for file retrieval. This spectrum of possible variations is analogous to the variations previously discussed above in connection with step 450 of FIG. 4 regarding the edge-based embodiment of FIG. 3. Furthermore, in some variations of the proxy-based embodiment, logic module 520 may be configured to cause proxy server 500 to transmit multiple versions of the request to server 100, each such version containing a modified request (e.g., a different file name extension) corresponding to a different compression codec or to an uncompressed version. Operation in this manner may be useful in situations where proxy server 500 does not have a priori knowledge of precisely which compressed versions/formats are available from server 100.

In the event that server system 100 hosts (or can generate) a compressed version of the requested file in a format matching the accepted encoding list included in the request, then server 100 ultimately responds to the modified request by transmitting compressed file 540 to proxy server 500. In turn, proxy server 500 is operable to forward the compressed file to requesting client 160, where standard browser 170 will transparently decompress the file and display the contents as desired to the end user. Optionally, proxy server 500 is further operable (shown in FIG. 5 by logic module 560) to rename the compressed version so that its file name matches the original file name as originally requested by client 160. E.g., “foo.gz” is optionally renamed “foo,” matching the original expectations of client 160.

While not limiting the applicability or scope of the present invention, preferred embodiments of the present invention may offer particular advantage in the context of electronic file delivery intended for so-called “light” (or “thin”) network clients such as wireless devices. Increasingly, specialized network services provide content tailored for low-bandwidth, small form-factor client devices such as wireless handheld computers. Such content typically emphasizes text as opposed to imagery, and would be especially amenable to the automatic, transparent, substantially lossless network compression techniques provided by embodiments of the present invention disclosed herein.

Although the present invention has been described in detail, it should be understood that various changes, substitutions and alterations can be made hereto without departing from the spirit and scope of the invention as described by the appended claims. As just one example, where compression codecs are called for, practitioners may use combinations of multiple codecs. Furthermore practitioners may employ different codecs for different segments of network transmissions, such as using a particular compression codec or combination of codecs (that may or may not be accepted by downstream clients) for transmissions between and among origin servers, edge servers, and proxy servers, while using a different codec (accepted by the destination client browser) for transmissions to the destination client browser.

1. A method for efficiently delivering copies of a customer's electronic file across a client-server computer network, comprising:
hosting copies of the customer's file at a plurality of servers as a component of a service;
compressing the file using a compression codec as a further component of the service;
receiving, by a selected one of the servers, a network request for the file from a requesting client, the request specifying a list of recognized file encoding schemes including the compression codec; and
responding to the network request by transmitting the compressed file over the network from the selected server to the requesting client.

2. The method of claim 1, wherein compressing the file is performed dynamically in response to the network request as a further component of the service.

3. The method of claim 1, wherein compressing the file is performed in advance of the network request as a further component of the service.

4. The method of claim 1, wherein compressing the file is performed by compressing one or more copies of the file at one or more of the servers as a further component of the service.

5. The method of claim 1, wherein compressing the file is performed by first compressing the file, and subsequently distributing copies of the compressed file to the plurality of servers as a further component of the service.

6. The method of claim 1, wherein compressing the file is performed at least partly depending upon the file type of the file as a further component of the service.

7. The method of claim 1, wherein the compression codec is substantially lossless.

8. The method of claim 7, wherein compressing further includes removing file data that does not substantively affect display of the compressed file by a standard browser of the client as a further component of the service.

9. The business method of claim 8, wherein removing file data includes removing data selected from the group comprising source code comments and extra blank characters.

10. The method of claim 7, wherein the compression codec is embodied in the GZIP compression utility.

11. The method of claim 1, further comprising selecting the selected one of the servers to handle the request at least partly based upon one or more criteria indicating a relative quality of connectivity between the selected server and the requesting client, as a further component of the service.

12. The method of claim 11, wherein the connectivity criteria are selected from the group comprising geographical distance, topological distance, bandwidth, latency, jitter, financial cost, and political boundaries.

13. The method of claim 1, wherein the network is the Internet and the network request is an HTTP protocol request.

14. A method for transmitting compressed data from a hosting server to a requesting client across a computer network, comprising:
receiving a network request from the client for a file, the request specifying a list of acceptable encoding schemes;
dynamically compressing the file using a substantially lossless compression codec, in response to the network request, the compression codec being one of the acceptable encoding schemes; and
transmitting the compressed file from the hosting server to the client via the network in fulfillment of the request.

15. The method of claim 14 further comprising dynamically generating the requested file in response to the network request.

16. The method of claim 14 wherein dynamically compressing is performed at least partly depending upon a file type of the requested file.

17. The method of claim 14 wherein receiving the network request is performed by the hosting server.

18. The method of claim 14 wherein the hosting server is one of a plurality of content delivery servers, each of the servers hosting a copy of the file.

19. The method of claim 18, wherein the hosting server is a selected to receive the network request at least partly based upon one or more criteria of connectivity between the hosting server and the requesting client.

20. The method of claim 19, wherein the connectivity criteria are selected from a group comprising geographical distance, topological distance, bandwidth, latency, jitter, financial cost, and political boundaries.

21. The method of claim 14, wherein dynamically compressing further includes removing file data that does not substantively affect display of the compressed file by a standard browser of the client.

22. The method of claim 21, wherein removing file data includes removing data selected from the group comprising source code comments and extra blank characters.

23. The method of claim 14, wherein the substantially lossless compression codec is embodied in the GZIP compression utility.

24. The method of claim 14, wherein the network is the Internet and the network request is an HTTP protocol request.

25. The method of claim 14, wherein the requesting client includes a light wireless client.

26. A system for transmitting compressed data to a requesting client across a computer network, in response to a network request from the client for a file, the request specifying a list of acceptable encoding schemes, the system comprising:
a proxy server, operable to receive the network request from the client and, in response to said request, to generate a modified request for a version of the file that is compressed in accordance with a substantially lossless compression codec, the compression codec being one of the acceptable encoding schemes;
a hosting server, being configured to transmit, in response to the modified request, the compressed version of the file to the client via the network in fulfillment of the request.

27. The system of claim 26 wherein the modified request specifies a modified file name with an extension that identifies the compression codec.

28. The system of claim 26 wherein the proxy server is further operable to generate one or more additional modified requests, each of said requests corresponding to a different one of the acceptable encoding schemes for the file.

29. The system of claim 26 wherein the proxy server is operable to forward the modified request to the hosting server.

30. The system of claim 26 wherein the compressed version of the file is created dynamically in response to the network request.

31. The system of claim 26 wherein the compressed version of the file is created in advance of the network request.

32. The system of claim 26 wherein the hosting server is one of a plurality of content delivery servers, each of the servers hosting a copy of the file.

33. The system of claim 32, wherein the hosting server is selected to transmit the compressed file at least partly based upon one or more criteria of connectivity between the hosting server and the requesting client.

34. The system of claim 33, wherein the connectivity criteria are selected from a group comprising geographical distance, topological distance, bandwidth, latency, jitter, financial cost, and political boundaries.

35. The system of claim 26 wherein the compression codec is embodied in the GZIP compression utility.

36. The system of claim 26, wherein the network is the Internet and the network request is an HTTP protocol request.
